(19) United States
(12) Patent Application Publication
(10) Pub. No.: US 2010/0231556 A1
(43) Pub. Date: Sep. 16, 2010

(54) DEVICE, SYSTEM, AND COMPUTER-READABLE MEDIUM FOR AN INTERACTIVE WHITEBOARD SYSTEM

(75) Inventors: Anthony Mines, Sterling, VA (US); Stephen Bretherton, Falls Church, VA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: TANDBERG TELECOM AS, Lysaker (NO)

(21) Appl. No.: 12/721,149

(22) Filed: Mar. 10, 2010

Related U.S. Application Data
(60) Provisional application No. 61/158,971, filed on Mar. 10, 2009.

(30) Foreign Application Priority Data
Mar. 23, 2009 (NO) 20091210

(51) Int. Cl. G06F 3/041

(52) U.S. Cl. 345/178; 345/173

(57) ABSTRACT

A device, system, and computer-readable medium for an interactive whiteboard including an interface which receives a first control signal from a touch-sensitive display surface and a second control signal from a codec, the first control signal identifying a position on the touch-sensitive display surface, and the second control signal identifying a codec setting of the codec; and a processor which calculates, based on the first control signal and the second control signal, a corresponding position on a display screen of a computing device to the position on the touch-sensitive display surface, and which sends the corresponding position to the computing device.

### CROSS-REFERENCE TO RELATED APPLICATIONS

The present application claims the benefit under 35 U.S.C. §119 from U.S. Provisional Application No. 61/158,971, filed Mar. 10, 2009, and claims priority to Norwegian Patent Application No. 20091210, filed Mar. 24, 2009, which are both herein incorporated by reference in their entirety.

### BACKGROUND

1. Technological Field

The present disclosure relates to communication between an interactive whiteboard and other electronic devices, and more specifically to a device and method for integrating a video conferencing codec in an interactive whiteboard system.

2. Description of the Related Art

Whiteboards have been steadily replacing blackboards and/or chalkboards. A whiteboard is a white laminate display panel on which a user may write. Generally, a user may write on a whiteboard using a pen containing quickly drying ink that can easily be erased. Thus, like a chalkboard, a whiteboard may be used indefinitely.

With the advent and ubiquity of computers, it became practical that whiteboards and computers would be combined together. A whiteboard combined with a computer is referred to as an interactive whiteboard. An interactive whiteboard digitally records images and/or text written thereon to be later printed, reviewed, and/or transmitted.

Conventional interactive whiteboard systems include a touch-sensitive display surface allowing a user to operate an attached computer simply by touching an image projected on the touch-sensitive display surface. Thus, in addition to controlling the operation of the interactive whiteboard system from an attached computer, the user can operate the computer while the user is at the touch-sensitive display surface and while addressing an audience from the touch-sensitive display surface.

FIG. 1 shows a conventional interactive whiteboard system. The system includes a touch-sensitive display surface 101, a computer 103, and a projector 105. The components may be connected wirelessly, via Universal Serial Bus (USB), or via serial cables. The projector 105 connected to the computer 103 projects the computer screen image onto the touch-sensitive display surface 101. The touch-sensitive display surface accepts touch input from a finger or a pen tool, for example, and software drivers on the computer convert contact with the touch-sensitive display surface into mouse clicks or digital ink. Interactive whiteboards are available as front-projection, rear-projection, and flat-panel display (i.e., touch-sensitive display surfaces that fit over plasma or Liquid Crystal Display (LCD) display panels) models.

Interactive whiteboard systems are rapidly becoming important tools in education, conferencing, and video conferencing. Conventional video conferencing systems include a number of endpoints communicating real-time video, audio, and/or data streams over Wide Area Network (WAN), Local Area Network (LAN), and/or circuit switched networks. The endpoints include one or more displays, cameras, microphones, speakers, and/or data capture devices and a codec, which encodes and decodes outgoing and incoming streams, respectively. In locations where an interactive whiteboard is installed, the touch-sensitive display surface 101 may also be used as the display for the video conferencing system. Such a setup is shown in FIG. 2.

As shown in FIG. 2, the video output or display output of the computer 103 is connected to a video conferencing codec 202, and the video output or display output of the video conferencing codec 202 is connected to the projector 105. A video conferencing codec 202 may have several modes of video/display output, which includes outputting only the video conferencing video streams, or only the screen image of the computer, or combinations of both of the preceding (composite image).

As illustrated in FIG. 2, one mode of video output from the video conferencing codec 202 is a side-by-side mode where the screen image 201 from the computer 103 is displayed on one area of the touch-sensitive display surface 101 and a video stream from the video conferencing codec 202 is displayed on another area of the touch-sensitive display surface 101. The projected computer screen image 201 only covers parts of the image projected onto the touch-sensitive display surface 101 by the projector 105. Since the computer 103 is configured to interpret the entire touch-sensitive display surface 101 as the projected computer screen image 201, the coordinates of the projected computer screen image 201 no longer correspond to the coordinates of the screen image 203 displayed on the computer 103. Hence, when a user touches a point 205 on the interactive whiteboard representing a point in the projected computer image 201 (i.e., the “close window” icon in the top right corner of a web browser), this point 205 represents a different point 207 on the screen image 203 displayed on the computer's 103 local screen.

The video conferencing codec 202 may have several different video output modes where the computer image is placed in different parts of the projected image and/or in different sizes. Therefore, when operating an interactive whiteboard via a video conferencing codec 202, the interactive whiteboard will not function properly.

### SUMMARY

The present disclosure discloses a device, system, and computer-readable medium for an interactive whiteboard including an interface which receives a first control signal from a touch-sensitive display surface and a second control signal from a codec, the first control signal identifying a position on the touch-sensitive display surface, and the second control signal identifying a codec setting of the codec; and a processor which calculates, based on the first control signal and the second control signal, a corresponding position on a display screen of a computing device to the position on the touch-sensitive display surface, and which sends the corresponding position to the computing device.

As should be apparent, a number of advantageous features and benefits are available by way of the disclosed embodiments and extensions thereof. It is to be understood that any embodiment can be constructed to include one or more features or benefits of embodiments disclosed herein, but not others. Accordingly, it is to be understood that the embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 is a schematic overview of a conventional interactive whiteboard system;

FIG. 2 is a schematic overview of video conferencing codec integrated with an interactive whiteboard system;

FIG. 3 is a schematic overview illustrating an embodiment of the present disclosure;

FIG. 4 is a schematic overview of an embodiment of the present disclosure;

FIG. 5 is a schematic overview of another embodiment of the present disclosure;

FIG. 6 is a flow diagram illustrating the method according one embodiment of the present disclosure;

FIG. 7 shows different image layouts in an embodiment of the present disclosure; and

FIG. 8 illustrates a computer system upon which an embodiment of the present disclosure may be implemented.

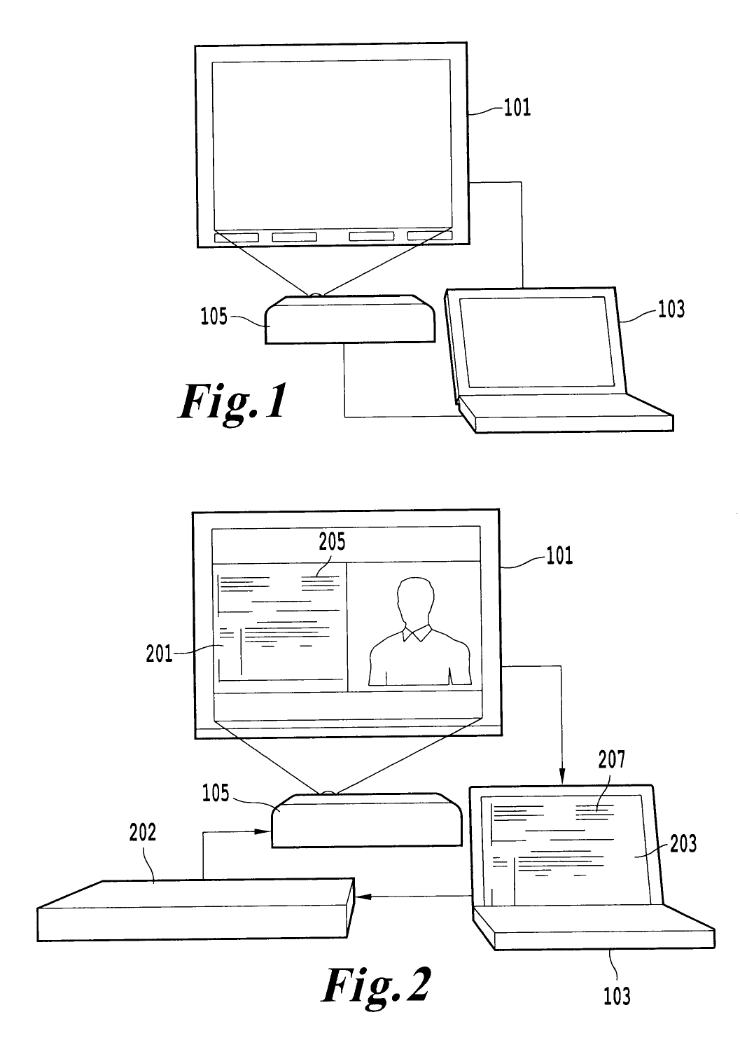

### DETAILED DESCRIPTION

The present disclosure relates to interactive whiteboard systems (also referred to as electronic whiteboards or digital whiteboards), and a device, system, method, and computer-readable medium for allowing integration of a video conferencing codec (coder/decoder) in such an interactive whiteboard system, without sacrificing interactive whiteboard functionality.

According to the present disclosure, a calibration logic unit is configured to at least receive control signals from a touch-sensitive display surface and from a video conferencing codec. The control signals from the touch-sensitive display surface may identify a position of an occurred event (i.e., an object touching the touch-sensitive display surfaces). Furthermore, the control signals from the touch-sensitive display surface may identify both an occurred event and the location (coordinates X₁, Y₁) of the occurred event. The control signal from the video conferencing codec may include a codec setting. Further, the control signal may include at least an identification of the current image layout used by the video conferencing codec, and the position in the layout of a screen image received from a computing device. The codec is connected to a projector projecting the codec's output or display image onto the touch-sensitive display surface. Based on the received control signals and preconfigured calibration profiles stored on the calibration logic unit, the calibration logic unit calculates a new set of coordinates (X₂, Y₂) identifying the corresponding position of the occurred event on the computer's local screen image. A control signal identifying at least the occurred event and the new set of coordinates is generated by the calibration logic unit and sent to the computer.

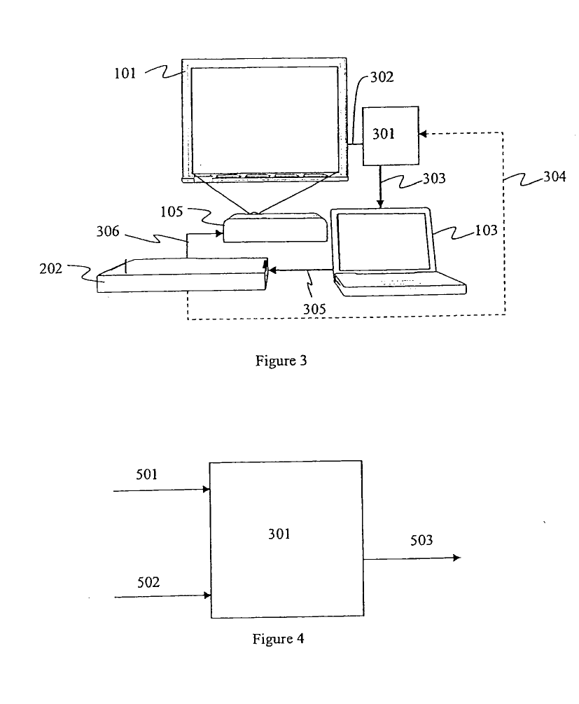

FIG. 3 is a schematic overview of an interactive whiteboard system comprising a calibration logic unit 301 according to an embodiment of the present disclosure. The calibration logic unit 301 is connected to a touch-sensitive display surface 101 via communication link 302. Further, the calibration logic unit 301 is connected to a video conferencing codec 202 and a computer 103 via communication link 303 and communication link 304, respectively. Communication links 302, 303, and 304 may be any type of wired medium (i.e., Universal Serial Bus (USB), a serial port cable, Local Area Network (LAN), internet, or the like) or wireless connection (Bluetooth™, Infrared (IR), WiFi, or the like).

A computing device, or computer, 103 is connected to the video conferencing codec 202 via communication link 305, allowing the computer 103 to send data signals from the computer 103 to the video conferencing codec 202. As used herein, a computer may refer to any computing device including, but not limited to, any personal computer (PC), video conferencing device, cellular device, smartphone, portable video device, or the like. The data signals from the computer 103 are typically the computer's desktop and associated active programs and applications, and represent the same image as displayed on the computer's local screen. The data signals from the computer 103 are hereinafter referred to as “Screen Image.” The video conferencing codec 202 is configured to output a display image to a projector 105 via communication link 306. The projector 105 projects the display image onto the touch-sensitive display surface 101. The communication link 305 and 306 may be any wired or wireless medium for transferring video and/or audio (i.e., Video Graphics Array (VGA), High-Definition Multimedia Interface (HDMI), Digital Visual Interface (DVI), Syndicat des Constructeurs d'Appareils Radiorécepteurs et Téléviseurs (SCART), Separate Video (S-Video), Composite Video, Component Video, or the like).

Video conferencing systems allow for simultaneous exchange of audio, video, and data information among multiple conferencing sites. Video conferencing systems comprise a codec (for coding and decoding audio, video, and data information), a camera, a display, a microphone, and speakers. Systems known as Multipoint Control Units (MCUs) perform switching functions to allow multiple sites to intercommunicate in a conference. An MCU may be a stand alone device operating as a shared central network recourse, or it may be integrated in the codec of a video conferencing system. An MCU links the sites together by receiving frames of conference signals from the sites, processing the received signals, and retransmitting the processed signals to appropriate sites. The conference signals include audio, video, data, and/or control information. A data conference signal may be a screen image from a computer connected to a video conferencing codec, and may be used for sharing data such as presentations, documents, applications, multimedia, or any program or application running on a computer. In a continuous presence conference, video signals and/or data signals from two or more sites are spatially mixed to form a composite video signal (i.e., composite image) for viewing by conference participants. The composite image is a combined image that may include live video streams, still images, menus, or other visual images from participants in the conference. There are unlimited number of possibilities of how the different video and/or data signals are spatially mixed, for example, size and position of the different video and data frames in the composite image. A codec or MCU typically have a set of preconfigured composite image (or image layout) templates defining the size and position of the video and/or data conference signals to be mixed in the different composite images. These composite image templates are hereinafter referred to as image layouts. A user may change the image layout during a video conference, or the codec or MCU may change the layout automatically during a video conference as participants at sites leave or join the video conference.

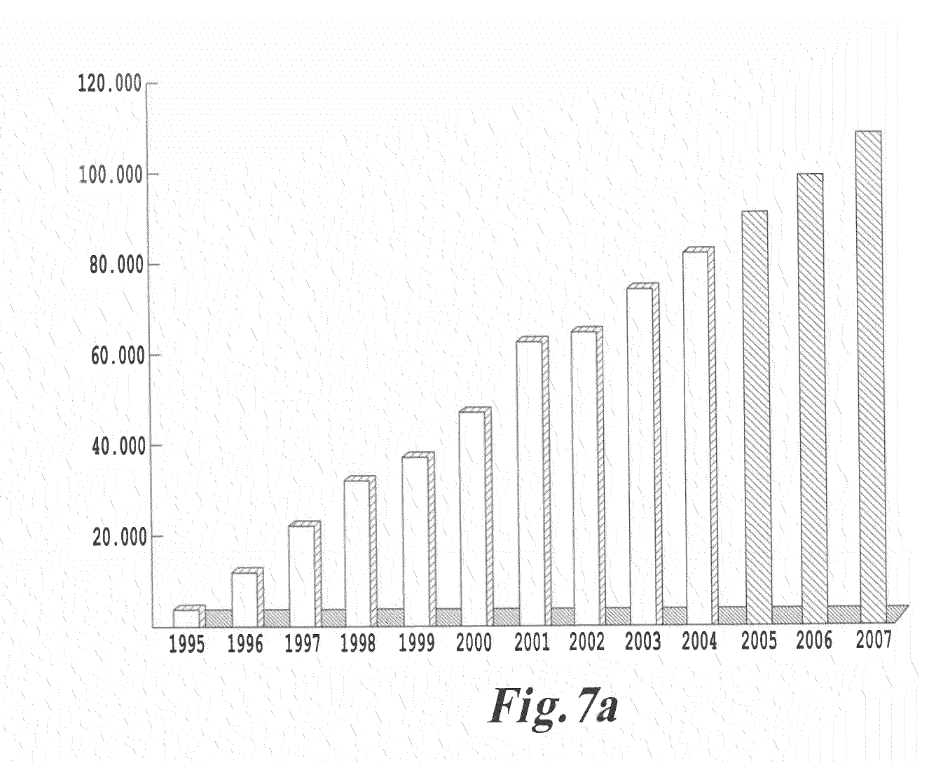

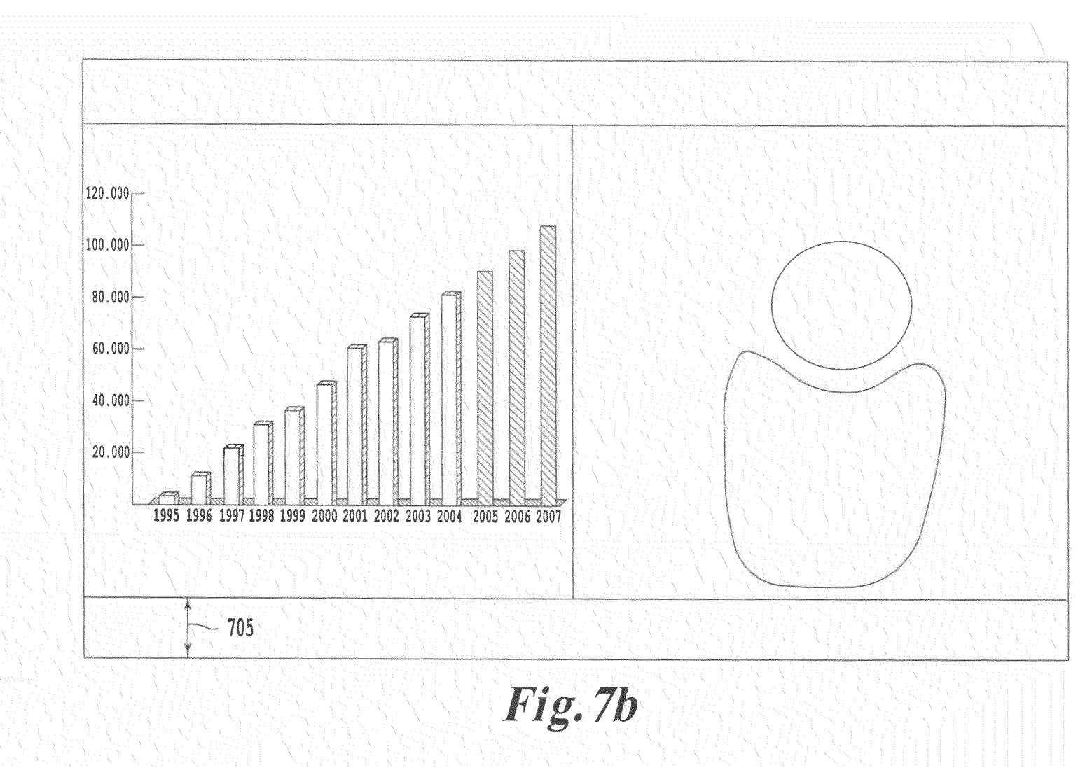

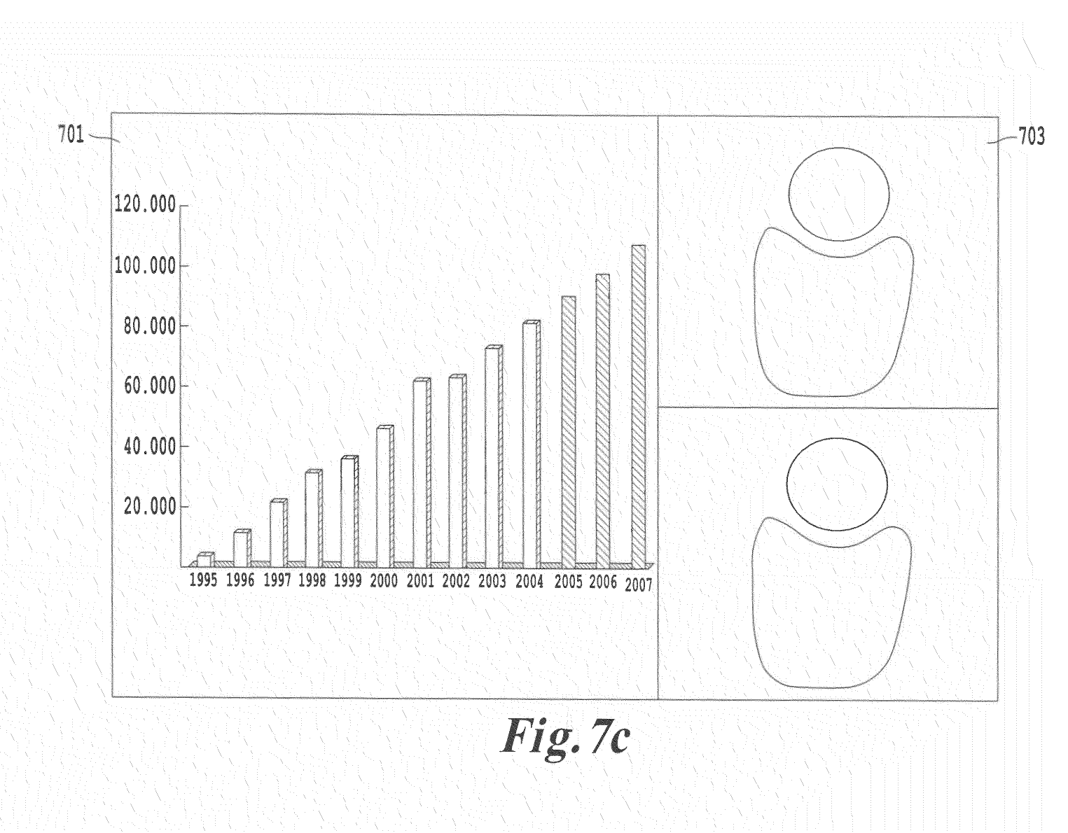

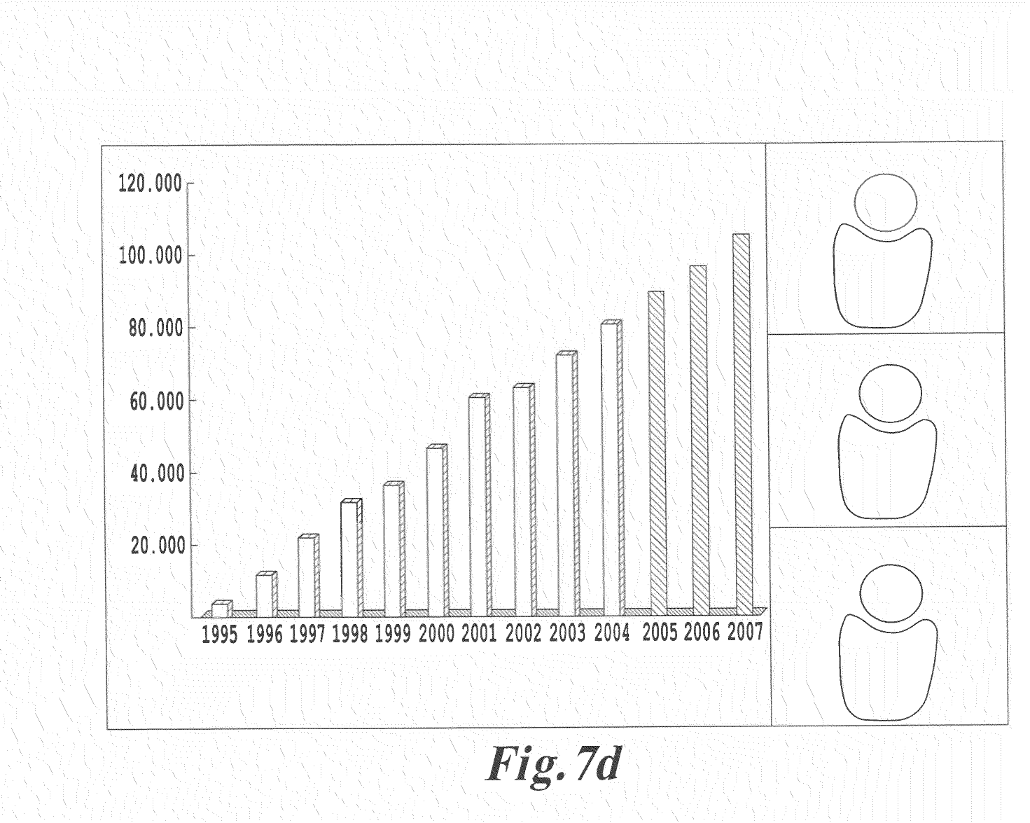

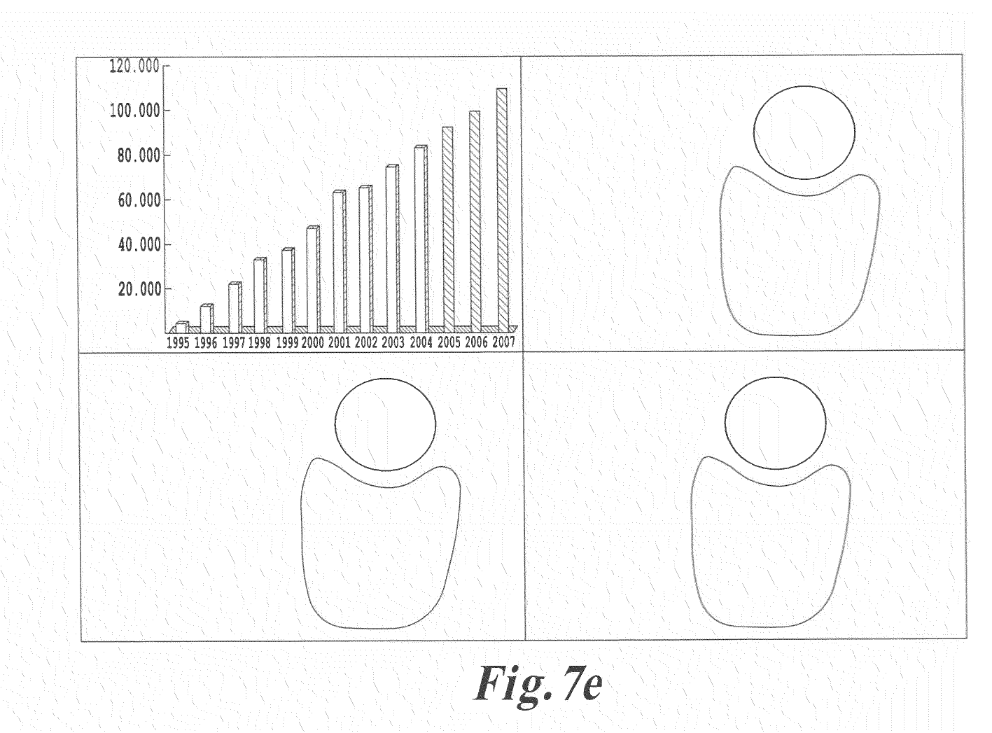

FIG. 7 shows five preconfigured image layouts. FIG. 7a illustrates an image layout where only one of the different video and/or data signals is displayed. This image layout is referred to as “Full Screen” since only one data signal or one video signal is displayed on the screen at any given time. FIG. 7b illustrates an image layout where the composite image is split in two equal halves, where one half comprises the computer image and the other half comprises a video signal. This image layout is hereinafter referred to as “Side-by-Side.” FIG. 7c illustrates an image layout where the composite image is split in three areas or regions, where one main area or region comprises the computer image and two smaller regions comprising different video signal. This image layout is hereinafter referred to as “2+1.”

FIG. 7d illustrates an image layout where the composite image is split in four areas or regions, where one main area or region comprises the computer image and three smaller regions comprising different video signal, hereinafter referred to as “3+1.” FIG. 7e illustrates an image layout where the composite image is split in four equally sized areas or regions, where one area or region comprises the computer image and the remaining three areas or regions comprise different video signals, hereinafter referred to as “4 Split.”

Further, the user or the codec/MCU may choose the position of the different video or data conference signals. For example, in FIG. 7c, the data signal may be displayed in area 701 or in area 703. A setting in the codec will indicate if the current content of an area or region in the layout is a data signal or a video signal. This setting is hereinafter referred to as “region source.”

If a codec is displaying images using the image layout “Full Screen,” the codec is only displaying one video or data signals at the time covering the entire display image. The video or data conference signal displayed is referred to as the “active signal.” If more than one video and/or data signals are received by the codec or MCU, the video and/or data signals that are not being displayed are referred to as “inactive signals.”

The codec may have a number of input ports for receiving data signals from various data sources. Data sources may be computers, document cameras, Video Cassette Recorded (VCR) units, Digital Versatile Disc or Digital Video Disc (DVD) units, or the like. In order to include data signals from a data source in a video conference, the codec may activate a data sharing setting.

Information about the codec's current settings related to image layout, active/inactive signals, data sharing settings, region source, and other settings relevant to the composition of the display image sent from the codec 202 to the projector 105 is hereinafter referred to as “codec setting.”

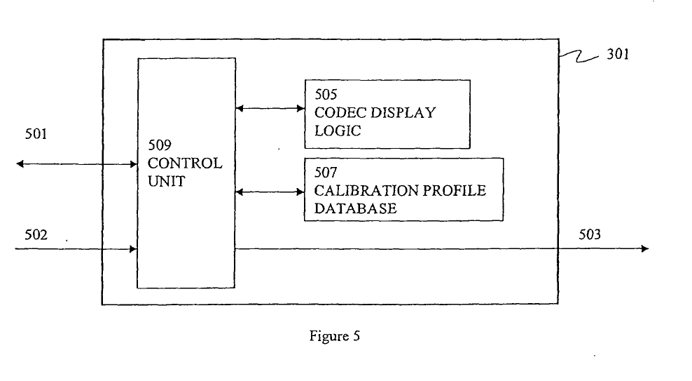

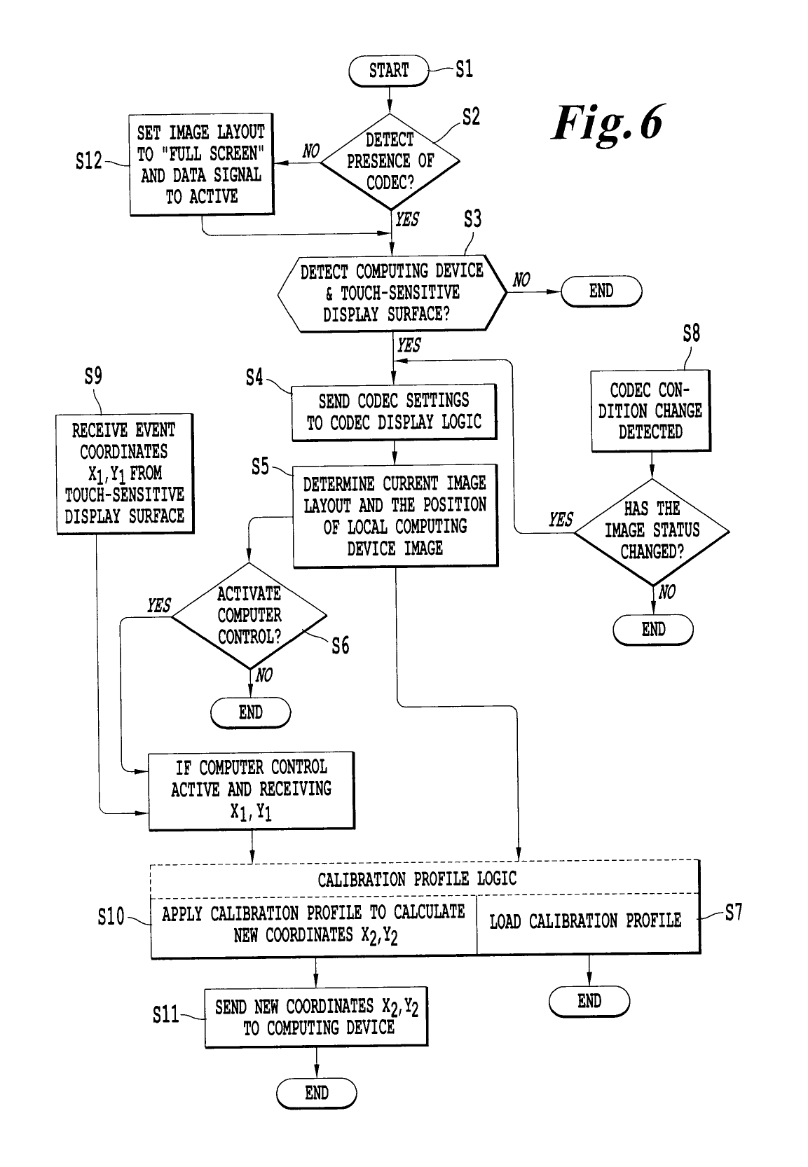

In the following, an exemplary embodiment of the calibration logic unit will be described in more detail with reference to FIGS. 3, 4, and 5. FIGS. 4 and 5 are schematic diagrams of the calibration logic unit 301. FIG. 6 is a flow diagram illustrating the interaction between the calibration logic unit 301, the video conferencing codec 202, and the interactive whiteboard system.

As shown in FIG. 4, the calibration logic unit 301 receives control signals 501 from the touch-sensitive display surface 101. The control signal 501 identifies an occurred event and the location of the occurred event. Events may include, but are not limited to, an object touching the touch-sensitive display surface 101, double tapping the surface 101, touching and dragging on the surface 101, touching and holding, or the like. The location of the occurred event is represented by x, y coordinates of the occurred event on the touch-sensitive display surface 101. The control signals from the touch-sensitive display surface 101 are control signals to the computer 103, which in response, convert the control signals into motion of the mouse pointer along X and Y axes on the screen and execute events (i.e., left click, right click, dragging, drawing, or the like).

Further, the calibration logic unit 301 receives a control signal 502 from the video conference codec 202. The control signal 502 from the video conferencing codec 202 identifies the current codec settings of the codec 202, for example, identification of the current image layout used by the video conferencing codec 202 if data sharing is activated, which video and/or data signal is/are the active signal(s), data source, or the like. According to one embodiment, the control signal 502 from the codec is American Standard Code for Information Interchange (ASCII) information.

According to an exemplary embodiment, the calibration logic unit 301 comprises a codec display logic 505, a calibration profile database 507, and a control unit 509. The control unit 509 is configured to communicate with the codec 202, the computer 103, and the touch-sensitive display surface 101. The codec display logic 505 is configured to receive and process the control signals 502 from the video conferencing codec 202 and determine the image layout currently used by the codec, if data sharing is active or not, which part of the composite image comprises the data conference signal (computer screen image), or the like. The calibration profile database 507 includes a set of preconfigured calibration profiles. Each image layout is associated with a particular calibration profile. It should be noted that a Side-by-Side configuration with the screen image to the left and a Side-by-Side configuration with the screen image to the right are defined as two different image layouts.

The calibration profiles define the relationship between a region or area of the composite image and the entire composite image. In other words, the calibration profile comprises instructions on how to calculate a new set of coordinates to be sent to the computer 103 based on the coordinates received from the touch-sensitive display surface 101. According to one embodiment, the calibration profiles are a set of position vectors. According to another embodiment, the calibration profile includes a mapping algorithm for changing an X_{I}, Y₁ touch coordinate within the displayed screen image 201 to an X₂, Y₂ computer mouse coordinate, such that X₁, Y₁ and X₂, Y₂ correspond to the same point in the displayed screen images and the screen image on the computer's local screen.

According to another embodiment, a calibration profile may be expressed as X₂=A*X₁+B and Y₂=C*Y₁+D, where A and C are scaling factors defining the relationship between the displayed screen image and the entire displayed image (i.e., composite image), and B and D are offset values compensating for when the entire display image area is utilized (as, for example, 705 in FIG. 7b). The calibration profiles may be preconfigured (i.e., for systems where the touch-sensitive display surface 101 and the projector 105 are bolted to the walls and/or a ceiling of a room), or they may be generated on certain events, for example, on system startup or when a button on the calibration logic unit 301 is pressed, a key sequence on the codec's remote control, or other commands.

According to an embodiment, the calibration profiles are generated by performing a calibration procedure. The calibration process may start when the system in FIG. 3 is turned on, or when requested by a user via a button or a remote control. A dialog box is projected onto the touch-sensitive display surface 101 to begin the calibration process. The dialog box instructs the user to touch the touch-sensitive display surface 101 at one or more calibration points. These calibration points may be ascertained by requesting the user to touch the touch-sensitive display surface 101 at the intersection of two lines, or other distinct marks which are projected onto the electronic whiteboard surface.

A first step in the calibration process may be touching the touch-sensitive display surface 101 in four points, one in each corner. This establishes the coordinates of the entire display image from the codec 202. Then a new image is displayed on the touch-sensitive display surface 101. The new image is a composite image having the same layout as one of the codec's image layout templates. The user is again instructed to touch the touch-sensitive display surface 101 at one or more calibration points. These calibration points lay within the region of the layout that would normally contain a computer screen image 203. The process is repeated for all image layouts of the codec 202. After the above process, the calibration logic unit 301 has all the information it needs to generate the calibration profiles discussed above.

As shown in FIG. 6, when the interactive whiteboard setup as illustrated in FIG. 4 is turned on, at step S1, the calibration logic unit 301 checks, at step S2, if a video conference codec 202 is connected to the calibration logic unit 301. If a video conference codec 202 is detected, the calibration logic unit 301 determines the model and manufacturer of the detected codec 202. If the model and manufacturer of the detected codec 202 is recognized by the calibration logic unit 301, the calibration logic unit 301 configures the codec 202 to provide its codec settings to the calibration logic unit 301, via communication link 305.

In response, the codec 202 sends, in step S4, its current codec settings to the calibration logic unit 301 in a control signal 501, and at least resends its codec settings at predefined events. The predefined events may include whenever any of the codec settings are changed (automatically or by a user), upon a user request (via a user interface), or at certain time intervals.

Next, if a codec 202 is detected in step S2, the calibration logic unit 301 checks, in step S3, if a computer 103 and touch-sensitive display surface 101 are connected to the calibration logic unit 301. If a touch-sensitive display surface 101 is detected, the calibration logic unit 301 determines the type of or model and manufacturer of, touch-sensitive display surface 101 connected via communication link 302. If a computer 103 is detected, then the calibration logic unit 301 sends a command signal to the computer 103 identifying the calibration logic unit 301 as a touch-sensitive display surface 101 of the type (or model and manufacturer) detected in step S3. Hence, it appears to the computer 103 that it receives control signals directly from a touch-sensitive display surface 101 via communication link 303.

As mentioned above, when configured, the codec 202 sends a control signal identifying the current codec settings to the calibration logic unit 301 (step S4).

According to one embodiment, the control signal is sent to the codec display logic 505, which is configured to interpret the codec 202 settings and, at least, determine the current image layout used by the codec 202 and the position of the screen image within the image layout (step S5).

When the current image layout has been determined in step S5, the calibration logic unit 301 loads the calibration profile (step S7) associated with the image layout currently used by the codec 202. According to an embodiment, the codec display logic 505 sends a control signal to the control unit 509 identifying the current image layout determined in step S5. In response, the control unit 509 sends a control signal to the calibration profile database 507 requesting the calibration profile associated with the image layout.

Based on the determined position and status of the screen image in step S5, the calibration logic unit 301 determines, in step S6, if computer control is possible. Computer control is set to active or non-active based on several factors. These factors may include current image layout, size of region or area comprising the screen image, type of active videoconferencing signal (DVD signal or computer signal), or the like. For example, if the current image layout of the codec 202 is a “4 Split” as shown in FIG. 7e, the size of the screen image displayed on the touch-sensitive display surface 101 may be considered too small and impractical for interactive operation, and computer control may be deactivated for the “4 Split” layout. Further, if the current image layout of the codec 202 is “Full Screen” as shown in FIG. 7a, and the status of the data conference signal (screen image) is inactive (not the displayed image), computer control is deactivated. The combinations of codec settings resulting in deactivated computer control may be configured by a user, and/or may depend on the size of the touch-sensitive display surface 101 or other factors.

If the codec settings change (step S8), either automatically or by a user (for example, when a new video conferencing caller calls in), the codec 202 sends a control signal to the calibration logic unit 301 identifying the new codec settings. If the new codec settings imply changes in the displayed image (i.e., new image layout, different active signal source, or the like), steps S4 through S7 are repeated.

When a user touches the touch-sensitive display surface 101 (i.e., event occurs) at a location (X₁, Y₁) (step S9), the touch-sensitive display surface 101 sends control signals to the calibration logic unit 301 via the communication link 302. If computer control is activated, the control signals identifying the location (X₁, Y₁), are processed by the control unit 509. Based, at least, on the coordinates (X₁, Y₁) and the calibration profile loaded in step S7, the control unit 509 calculates a new set of coordinates (X₂, Y₂). The calibration logic unit 301 then generates a new control signal identifying the occurred event and location of the occurred event, where the location is represented by the new coordinates (X₂, Y₂). The new control signal is sent to the computer 103 via communication link 303 in step S11, where the new control signals are parsed and executed as if they were received directly from the touch-sensitive display surface 101.

If a codec 202 is not detected in S2, the calibration logic unit 301 applies the “Full Screen” calibration profile for calculating the new coordinates (X₂, Y₂).

The calibration logic unit 301 may be implemented as a stand alone device, or could be integrated in the codec 202, on the computer 103, or on a central network, such as an MCU.

According to one exemplary embodiment, if a codec 202 is not detected in step S2, the control unit 509 may generate a control signal indicating that a codec 202 is present, that the codec setting is “Full Screen,” and that the data signal is active. If step S3 is positive, the generated control signal is sent to the codec display unit 505 in step S4, and steps S5 through S11 are repeated.

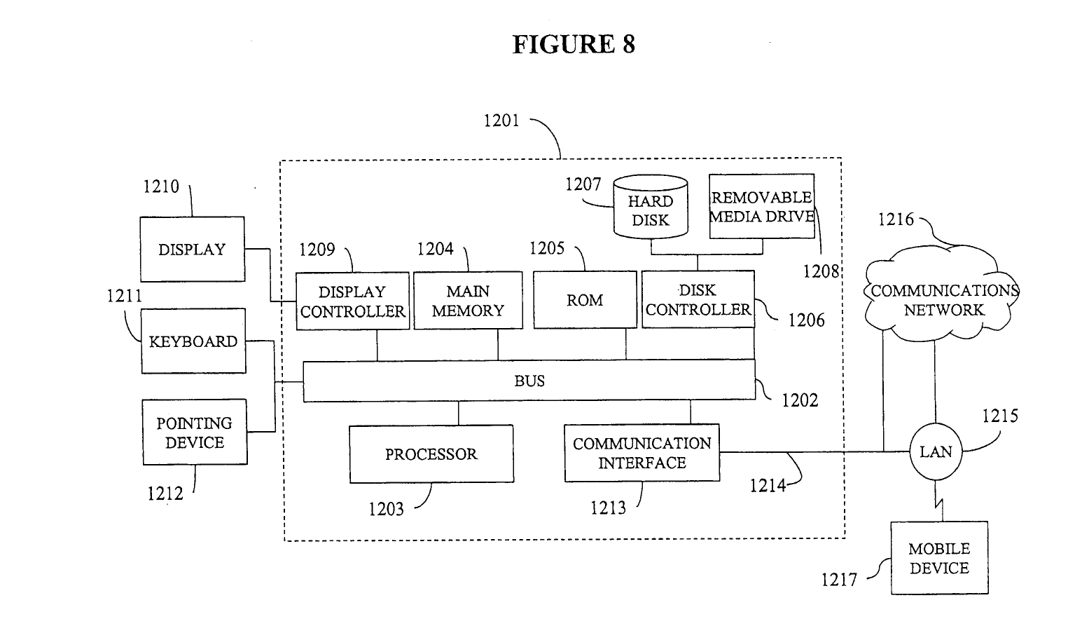

FIG. 8 illustrates a computer system 1201 upon which an embodiment of the interactive whiteboard system, according to the present embodiments, may be implemented. The computer system 1201 may include a combination of the codec 202 and the calibration logic unit 301. Other embodiments may combine the touch-sensitive display surface 101 and the calibration logic unit 301, or the computer system 1201 may be a combination of the computer 103, the codec 202, and the calibration logic unit 301. The computer system 1201 includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as the touch panel display 101 or a liquid crystal display (LCD), for displaying information to a computer user. The GUI 308, for example, may be displayed on the display 1210. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media, on the contrary, includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Further, it should be appreciated that the exemplary embodiments of the present disclosure are not limited to the exemplary embodiments shown and described above. While this invention has been described in conjunction with exemplary embodiments outlined above, various alternatives, modifications, variations and/or improvements, whether known or that are, or may be, presently unforeseen, may become apparent. Accordingly, the exemplary embodiments of the present disclosure, as set forth above are intended to be illustrative, not limiting. The various changes may be made without departing from the spirit and scope of the invention. Therefore, the disclosure is intended to embrace all now known or later-developed alternatives, modifications, variations and/or improvements.

1. A calibration logic device comprising:
an interface configured to receive a first control signal from a touch-sensitive display surface and a second control signal from a codec, the first control signal identifying a position on the touch-sensitive display surface, and the second control signal identifying a codec setting of the codec; and
a processor configured to calculate, based on the first control signal and the second control signal, a corresponding position on a display screen of a computing device to the position on the touch-sensitive display surface, and to send the corresponding position to the computing device.

2. The calibration logic device of claim 1, wherein the position on the touch-sensitive display surface identifies a position of an occurred event, the occurred event including at least one of touching the touch-sensitive display surface, double tapping or clicking the touch-sensitive display surface, and performing a dragging motion on the touch-sensitive display surface.

3. The calibration logic device of claim 1, wherein the position on the touch-sensitive display surface is represented by X₁, Y₁ coordinates.

4. The calibration logic device of claim 3, wherein the corresponding position on the display screen of the computing device is represented by X₂, Y₂ coordinates.

5. The calibration logic device of claim 1, wherein the second control signal includes American Standard Code for Information Interchange (ASCII) information.

6. The calibration logic device of claim 1, further comprising:
a calibration profile database configured to store a plurality of calibration image layouts,
wherein the codec setting of the codec is associated with one of the plurality of calibration image layouts.

7. The calibration logic device of claim 6, wherein the corresponding position on the display screen of the computing device is calculated based on the touch-sensitive display surface and at least one of the plurality of calibration image layouts.

8. The calibration logic device of claim 1, wherein the processor determines at least one of a model and manufacturer of the codec and a model and manufacturer of the touch-sensitive display surface.

9. The calibration logic device of claim 1, wherein the codec setting identifies at least one of an image layout, an active or inactive signal, a data sharing setting, and a region source.

10. The calibration logic device of claim 1, wherein the second control signal further identifies a position in the codec setting of a screen image generated on the computing device.

11. A system comprising:
a touch-sensitive display surface;
a codec; and
a calibration logic device configured to,
receive a first control signal from the touch-sensitive display surface and a second control signal from the codec, the first control signal identifying a position on the touch-sensitive display surface, and the second control signal identifying a codec setting of the codec,
calculate, based on the first control signal and the second control signal, a corresponding position on a display screen of a computing device to the position on the touch-sensitive display surface, and
send the corresponding position to the computing device.

12. The system of claim 11, wherein the position on the touch-sensitive display surface identifies a position of an occurred event, the occurred event including at least one of touching the touch-sensitive display surface, double tapping or clicking the touch-sensitive display surface, and performing a dragging motion on the touch-sensitive display surface.

13. The system of claim 11, wherein the position on the touch-sensitive display surface is represented by X₁, Y₁ coordinates.

14. The system of claim 13, wherein the corresponding position on the display screen of the computing device is represented by X₂, Y₂ coordinates.

15. The system of claim 11, wherein the second control signal includes American Standard Code for Information Interchange (ASCII) information.

16. The system of claim 11, wherein the calibration logic device further comprises:
a calibration profile database configured to store a plurality of calibration image layouts,
wherein the codec setting of the codec is associated with one of the plurality of calibration image layouts.

17. The system of claim 16, wherein the corresponding position on the display screen of the computing device is calculated based on the touch-sensitive display surface position and at least one of the plurality of calibration image layouts.

18. The system of claim 11, wherein the calibration logic device determines at least one of a model and manufacturer of the codec and a model and manufacturer of the touch-sensitive display surface.

19. The system of claim 11, wherein the codec setting identifies at least one of an image layout, an active or inactive signal, a data sharing setting, and a region source.

20. A computer-readable storage medium including computer executable instructions, wherein the instructions, when executed by the computer, cause the computer to perform a method comprising:
receiving a first control signal from a touch-sensitive display surface and a second control signal from a codec, the first control signal identifying a position on the touch-sensitive display surface, and the second control signal identifying a codec setting of the codec;
calculating, based on the first control signal and the second control signal, a corresponding position on a display screen of a computing device to the position on the touch-sensitive display surface; and
sending the corresponding position to the computing device.
